(19) United States
(12) Patent Application Publication
(10) Pub. No.: US 2013/0285881 A1
(43) Pub. Date: Oct. 31, 2013

(54) Portable Electronic Device Having Dual Displays Provided on Front and Rear Surfaces Thereof and for Operations Thereon

(71) Applicants: Jyh-Yi LOO, New Taipei City (TW); Cheng Jung LEE, New Taipei City (TW)

(72) Inventors: Jyh-Yi LOO, New Taipei City (TW); Cheng Jung LEE, New Taipei City (TW)

(21) Appl. No.: 13/693,057

(22) Filed: Dec. 4, 2012

(30) Foreign Application Priority Data
Apr. 27, 2012 (TW) 101207990

(51) Int. Cl. G06F 3/14

(52) U.S. Cl. CPC G06F 3/1423
USPC 345/1.1

(57) ABSTRACT

The present invention provides a portable electronic device having dual displays provided on front and rear surfaces thereof and for operations thereon, comprising a housing, a first display operation unit, a second display operation unit and a control unit; the housing having a front surface and a rear surface; the first and second display operation units provided on the front and rear surface of the housing respectively; and the control unit provided inside the housing and electrically connected to the first and second display operation units for transmitting signals and switching the first and second display operation units to synchronous and asynchronous display modes; and wherein the housing comprises two individual components pivotally attached to each other such that they can be rotated to show their respective front surfaces to realize the design of dual displays and to facilitate various control operations on the dual displays adapted for diverse applications.

### TECHNICAL FIELD OF THE INVENTION

The present invention is related to a portable electronic device having dual displays provided on front and rear surfaces thereof and for operations thereon, in particular, to an electronic device configured to be a combination of both a backlight color type of display and a black-white cholesteric reflective type of display with synchronous and asynchronous display modes.

### DESCRIPTION OF THE PRIOR ART

As the technology of electronic communication advances, various types of portable electronic devices fulfill the needs of consumers in different applications. Such electronic devices may include such as mobile phones, personal digital assistant (PDA), electronic books (e-books), touch panel, light-weight portable laptop computers and those designed specifically for displaying texts, graphics and images, and are well-known for their great convenience and portability.

However, most portable electronic devices with displays available in the current market utilize backlight color e of displays that requires significant amount of electricity and power, which could be harmful to users' vision after extended period of viewing of such type of displays and, in particular, the viewing of displays that emit blue light and white light at high intensity. Furthermore, users tend to find themselves having difficulties viewing the screen of such type of display and reading the content displayed thereon under a direct sunlight or in the outdoor environment.

In addition, as shown in FIG. 1, the use of one single display unit 20 cannot satisfy the needs of the application of multi-displays. Users are still being limited to choose one type of display of single material or type, and as a result, larger data transfer flow is required, which is likely to cause problems such as network congestion or cut-offs and is also likely to be of greater costs. Therefore, there is a need to improve the display technology adapted to known portable electronic devices.

### SUMMARY OF THE INVENTION

A primary objective of the present invention is to provide a portable electronic device having dual displays provided on front and rear surfaces thereof and for operations thereon such that the design of dual displays and dual touch operation controls can be realized and adapted for various applications.

To achieve the abovementioned objective, the present invention provides a portable electronic device having dual displays provided on front and rear surfaces thereof and for operations thereon, comprising a housing, a first display operation unit, a second display operation unit and a control unit; said housing having a front surface and a rear surface; said first display operation unit provided on said front surface of said housing; said second display operation unit provided on said rear surface of said housing; and said control unit provided in an internal of said housing and electrically connected to said first display operation unit and said second display operation unit, for transmitting signals and for switching said first display operation unit and said second display operation unit to a synchronous display mode and an asynchronous display mode.

The display operation units of the present invention can be a backlight electronic type of displays or a black-white cholesteric reflective type of displays; and wherein the asynchronous display mode displays signals processed and displayed individually by said first display operation unit and said second display operation unit; and wherein the synchronous display mode displays signals processed and displayed synchronously by both said first display operation unit and said second display operation unit. In addition, the front surface and the rear surface of the housing are attached to each other via a rotating member such that the first display operation unit and the second display operation unit can be rotated to show said front surfaces thereof respectively in order to perform said synchronous display mode.

With the abovementioned technical features and in comparison with the conventional portable electronic devices with one single backlight color display, the application of the present invention is greater as it allows users to choose black and white displays and solves the problem associated with the data transfer, network congestion, delay or cut-off of the device while reducing the amount of power consumption. Furthermore, the present invention is able to utilize the design of dual displays to realize the diverse applications of synchronous and asynchronous of dual touch operation controls in order to overcome the drawbacks of known arts.

### BRIEF DESCRIPTION OF THE DRAWINGS

FIG. 1 is an illustration showing an outer appearance of a conventional portable electronic device.

FIG. 2 is an illustration showing an outer appearance of the present invention;

FIG. 3 is a block diagram showing the hardware component of the present invention;

FIG. 4 is an illustration showing a first preferred embodiment of the present invention;

FIG. 4A is an enlarged view of a portion of FIG. 4;

FIG. 5 is an illustration showing a second preferred embodiment of the present invention;

FIG. 5A is an enlarged view of a portion of FIG. 5;

FIG. 6 is an illustration showing a third preferred embodiment of the present invention; and

FIG. 6A is an enlarged view of a portion of FIG. 6;

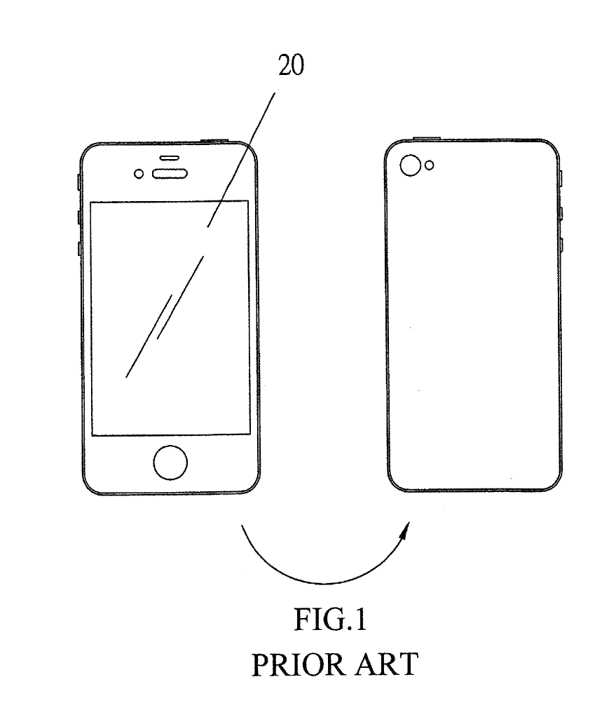

### DETAILED DESCRIPTION OF THE PREFERRED EMBODIMENTS

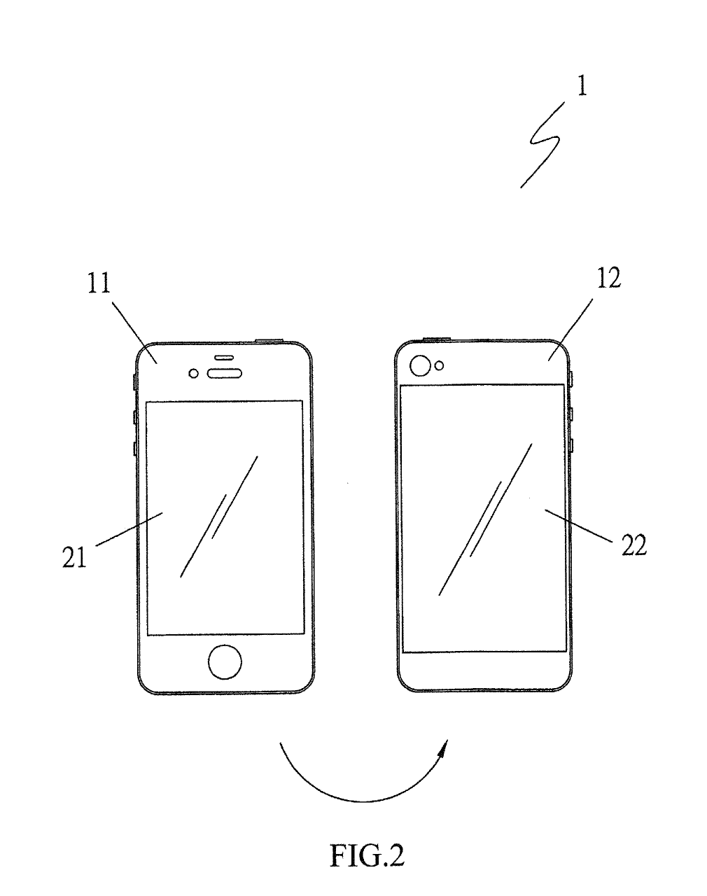

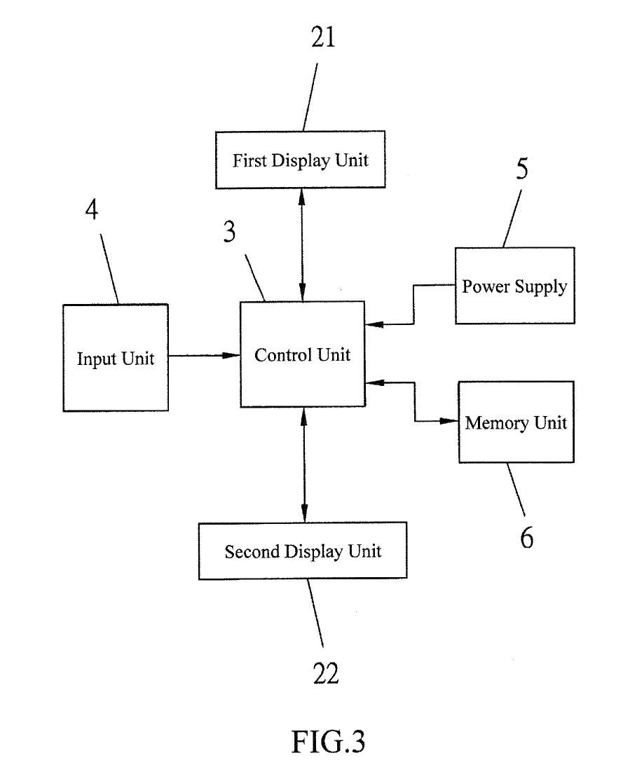

As shown in FIGS. 2 and 3, the present invention provides a portable electronic device having dual displays provided on front and rear surfaces thereof and for operations thereon, comprising a housing 1, a first display operation unit 21, a second display operation 22 and a control unit 3; the housing 1 having a front surface 11 and a rear surface 12; the first display operation unit 21 provided on the front surface 11 of the housing 1; the second display operation unit 22 provided on the rear surface 12 of the housing 1; and the control unit 3 provided in an internal of the housing 1 and electrically connected to the first display operation unit 21 and the second display operation unit 22, for transmitting signals and for switching the first display operation unit 21 and the second display operation unit 2 to a synchronous display mode and an asynchronous display mode.

In addition, the control unit 3 further comprises an input unit 4, a power supply 5 and a memory unit 6 electrically connected thereto; and wherein the input unit 4 is provided for inputting control signals, the power supply 5 is provided for supplying an electricity, and the memory unit 6 is provided for data storages. Furthermore, the first display operation unit 21 and the second display operation unit 22 can be backlight electronic type of displays, black-white cholesteric reflective type of displays or self-emissive type of displays, such as OLED, onto which the operation signals can be inputted directly. The asynchronous display mode displays signals processed and displayed individually by the first display operation unit 21 and the second display operation unit 22; whereas the synchronous display mode displays signals processed and displayed synchronously by both the first display operation unit 21 and the second display operation unit 22.

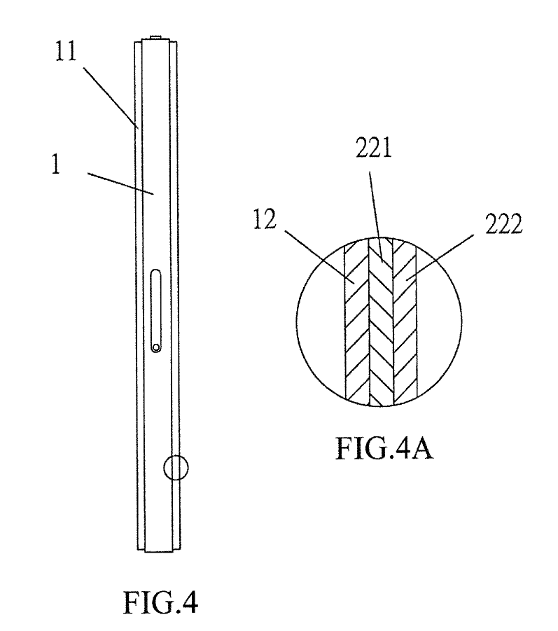

FIGS. 4 and 4A show a first preferred embodiment of the portable electronic device having dual displays provided on front and rear surfaces thereof and for operations thereon of the present invention. Accordingly, the first display operation unit 21 is a conventional liquid crystal display screen provided for displaying color image signals and the second display operation unit 22 is an electronic paper 221 provided for displaying black and white image signals. The electronic paper 221 can be attached to the rear surface 12 of the housing 1, which is further covered by a protective film 222 of the material of a touch-screen glass or plastics in order to form a display screen that is light and thin as well as of the property of being energy efficient. The first preferred embodiment of the present invention can be advantageously applied to products including such as touch panel, smart phones and laptop computers but not limited to the application of such products.

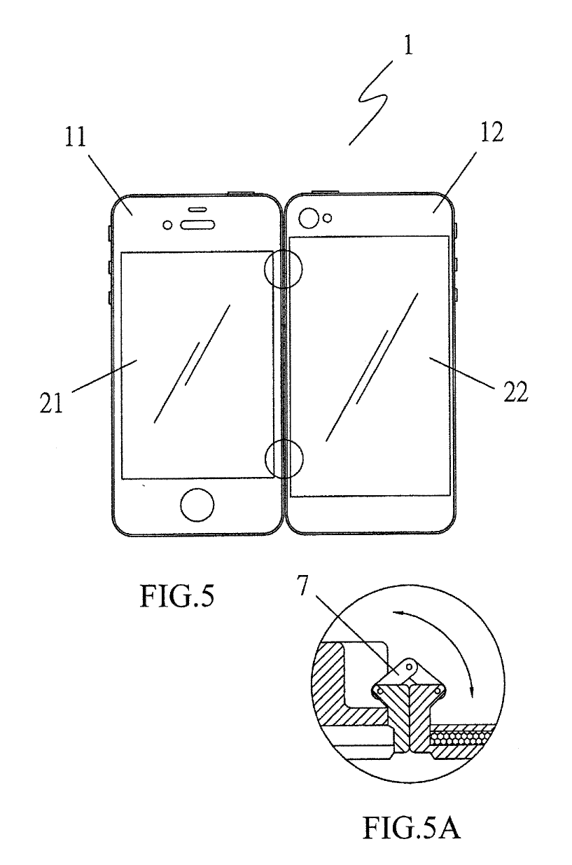

FIGS. 5 and 5A show a second preferred embodiment of the portable electronic device having dual displays provided on front and rear surfaces thereof and for operations thereon of the present invention. To realize the switch of the first display operation unit 21 and the second display operation unit 22 to a synchronous display mode, the front surface 11 and the rear surface 12 of the housing of the present invention can be structurally designed to be two individual components such that the two components are pivotally attached to each other via a rotating member 7; and wherein the rotating member 7 comprises a hidden electrode provided in the internal of the housing such that the first display operation unit 21 and the second display operation unit 22 can be rotated with respect to each other by a degree exceeding 180° and such that the first display operation unit 21 and the second display operation unit 22 are being advantageously rotated to show the front surfaces thereof respectively and to allow easy and convenient access of user operations.

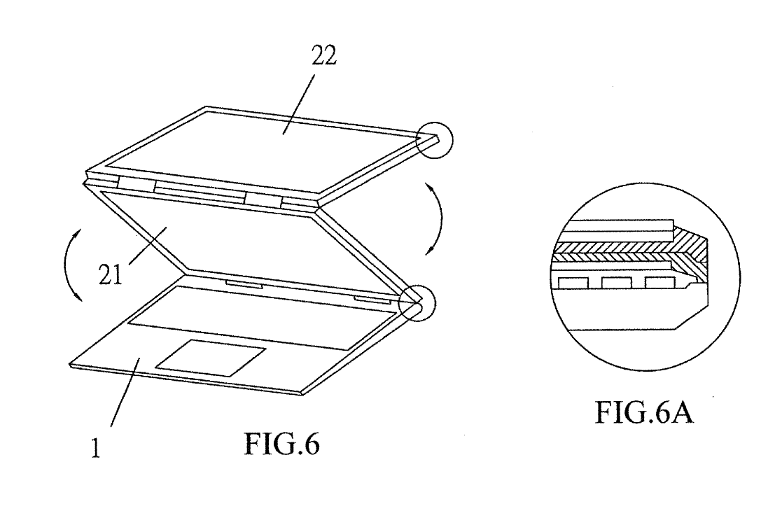

FIGS. 6 and 6A show a third preferred embodiment of the portable electronic device having dual displays provided on front and rear surfaces thereof and for operations thereon of the present invention. Accordingly, one end of the first display operation unit 21 is pivotally attached to a lateral side of the housing 1, and the second display operation unit 22 is pivotally attached to another end of the first display operation unit 22 such that the two can be rotated with respect to each other by a degree exceeding 180°, which differs from the aforementioned preferred embodiments in that the third preferred embodiment comprises three individual components of the first display operation unit 21, the second display operation unit 22 and the housing 1 and also in that as the device of the present invention is at a fully deployed state, the first display operation unit 21 and the second display operation unit 22 are being rotated to show their respective front surfaces in order to allow the use of the functions associated with the dual displays, which too allows the user operations of conventional functions of a single display when the device of the present invention is at a folded state.

What is claimed is:

1. A portable electronic device having dual displays provided on front and rear surfaces thereof and for operations thereon, comprising:
a housing having a front surface and a rear surface;
a first display operation unit provided on said front surface of said housing;
a second display operation unit provided on said rear surface of said housing; and
a control unit provided in an internal of said housing and electrically connected to said first display operation unit and said second display operation unit, for transmitting signals and for switching said first display operation unit and said second display operation unit to a synchronous display mode and an asynchronous display mode.

2. The portable electronic device having dual displays provided on front and rear surfaces thereof and for operations thereon according to claim 1, wherein said asynchronous display mode displays signals processed and displayed individually by said first display operation unit and said second display operation unit.

3. The portable electronic device having dual displays provided on front and rear surfaces thereof and for operations thereon according to claim 1, wherein said synchronous display mode displays signals processed and displayed synchronously by both said first display operation unit and said second display operation unit.

4. The portable electronic device having dual displays provided on front and rear surfaces thereof and for operations thereon according to claim 1, wherein said first display operation unit and said second display operation unit are backlight electronic type of displays.

5. The portable electronic device having dual displays provided on front and rear surfaces thereof and for operations thereon according to claim 1, wherein said first display operation unit and said second display operation unit are black-white cholesteric reflective type of displays.

6. The portable electronic device having dual displays provided on front and rear surfaces thereof and for operations thereon according to claim 1, wherein said first display operation unit and said second display operation unit are self-emissive type of displays.

7. The portable electronic device having dual displays provided on front and rear surfaces thereof and for operations thereon according to claim 1, wherein said control unit further comprises an input unit, a power supply and a memory unit electrically connected thereto; and wherein said input unit is provided for inputting control signals, said power supply is provided for supplying an electricity, and said memory unit is provided for data storages.

8. The multi-directional controller with a display integrated therein according to claim 1, wherein said first display operation unit and said second display operation unit are touch type screens for inputting control signals.

9. The multi-directional controller with a display integrated therein according to claim 1, wherein said first display operation unit is a touch type screen, and said second display operation unit is a non-touch type screen utilizing buttons for inputting control signals.

10. The multi-directional controller with a display integrated therein according to claim 1, wherein said first display operation unit and said second display operation unit utilize button inputs, touches, voice controls, hand gestures and hand writing pens for inputting control signals.

11. The multi-directional controller with a display integrated therein according to claim 1, wherein said first display operation unit is a thin film transistor (TFT) liquid crystal display or an organic light emitting diode (OLED) liquid crystal display for displaying color image signals.

12. The multi-directional controller with a display integrated therein according to claim 1, wherein said second display operation unit is an electronic paper for displaying black and white image signals.

13. The multi-directional controller with a display integrated therein according to claim 1, wherein said front surface and said rear surface of said housing are two individual components connected to each other via a rotating member; wherein said rotating member comprises an electrode provided in said internal of said housing such that said first display operation unit and said second display operation unit are rotated to show said front surfaces thereof respectively in order to perform said synchronous display mode.

14. A portable electronic device having dual displays provided on front and rear surfaces thereof and for operations thereon, comprising:
a housing having a front surface and a rear surface;
a first display operation unit, having one end pivotally attached to a lateral side of said housing;
a second display operation unit, pivotally attached to another end of said first display operation unit; and
a control unit, provided in an internal of said housing and electrically connected to said first display operation unit and said second display operation unit, for transmitting signals and for switching said first display operation unit and said second display operation unit to a synchronous display mode and an asynchronous display mode.
